(19) United States
(12) Patent Application Publication
(10) Pub. No.: US 2012/0075208 A1
(43) Pub. Date: Mar. 29, 2012

(54) INFORMATION PROCESSING PROGRAM, INFORMATION PROCESSING APPARATUS AND METHOD THEREOF

(75) Inventors: Fumihiko TAMIYA, Kyoto (JP); Satoru Nakata, Kyoto (JP); Makoto Nakazono, Kyoto (JP)

(73) Assignee: NINTENDO CO., LTD., Kyoto (JP)

(21) Appl. No.: 13/014,121

(22) Filed: Jan. 26, 2011

(30) Foreign Application Priority Data
Sep. 27, 2010 (JP) 2010-215503

(51) Int. Cl. G06F 3/041; G06F 3/01

(52) U.S. Cl. 345/173; 345/156

(57) ABSTRACT

A game apparatus includes a first LCD and a second LCD, and a CPU displays a game screen on the LCDs according to a game program and layout data. On the second LCD, a touch panel is provided. On the second LCD, a plurality of objects are displayed. When a help mode key is touched, a “?” cursor is displayed near each of objects for which a description message is prepared (target object), and if any “?” cursor is touched, a detailed explanation of the target object indicated by the “?” cursor is displayed on the first LCD as a description message.

### CROSS REFERENCE OF RELATED APPLICATION

The disclosure of Japanese Patent Application No. 2010-215503 is incorporated herein by reference.

### BACKGROUND OF THE INVENTION

1. Field of the Invention

The invention relates to an information processing program, an information processing apparatus and a method thereof. More specifically, the present invention relates to an information processing program, an information processing apparatus and a method thereof that display a description message for describing a content and/or a function of characters, buttons, icons, etc. (objects).

2. Description of the Related Art

Conventionally, in an information processing apparatus, one for displaying functional descriptions of buttons and icons that are displayed on a screen has been known. For example, a Patent Document 1 discloses that when a functional description icon is dragged to an explanation target object, a functional description of the explanation target object is displayed. Furthermore, a Patent Document 2 discloses that when each tool button is designated by a cursor, help information of the tool button is displayed at a set display position.

[Patent Document 1] Japanese patent No. 2803236 [G06F 3/14 3/02 3/14]

[Patent Document 2] Japanese Patent Laid-open No. 8-115194 [G06F 3/14]

However, in the aforementioned Patent Document 1 and Patent Document 2, it was impossible to previously perceive which target object allows for a display of the help text or the help information. More specifically, in a case that the target objects that allow for a display of the help text or the help information and the target objects that do not allow for a display of the help text or the help information are mixed, it is impossible to perceive whether or not the help text or help information can be displayed until each target object is designated by a cursor, etc. in the Patent Document 1 and the Patent Document 2.

### SUMMARY OF THE INVENTION

Therefore, it is a primary object of the present invention to provide a novel information processing program, a novel information processing apparatus and a method thereof.

Another object of the present invention is to provide an information processing program, an information processing apparatus and a method thereof capable of easily grasping an object about which a description message is prepared.

The present invention employs following features in order to solve the above-described problems. It should be noted that supplements, etc. show examples of a corresponding relationship with the embodiments described later for easy understanding of the present invention, and do not limit the present invention.

A first aspect is storage medium storing an information processing program to be executed by a processor of an information processing apparatus that displays a plurality of objects on a screen of a monitor and has a storage storing a description message of at least one object, the information processing program causes the processor to function as: a first displayer which displays a presence/absence indication for indicating whether or not there is a description message for each object on the screen when a predetermined input is accepted from an inputter; a first determiner which determines whether or not the input accepted from the inputter designates a target object in association with any one of the presence indications; and a second displayer which reads a relevant description message from the storage and displays the same on the screen when the first determiner determines that the target object in association with any one of the presence indications is designated.

In the first aspect, a first displayer displays a presence/absence indication for indicating whether or not there is a description message for each object on the screen when a predetermined input is accepted by an inputter in a state that the objects are displayed on the screen of the monitor. A first determiner determines whether or not the input accepted from the inputter in a state the objects and presence/absence indications are displayed on the screen designates a target object (object about which the description message is stored in the storage) in association with any one of the presence indications. When the first determiner determines that the target object in association with any one of the presence indications is designated, a second displayer reads a relevant description message from the storage and displays the same on the screen.

According to the first aspect, if the user inputs a predetermined input by the inputter, a presence or absence of a description message is displayed for each object, and therefore, the user can easily grasp the object capable of displaying the description message.

A second aspect is a storage medium according to the first aspect, wherein the first displayer includes a differently displayer which displays a target object about which the description message is stored in the storage in a manner different from the other objects, and the first determiner determines whether or not the input designates the target object.

In the second aspect, the first displayer displays the target object and the other objects in a different display manner, such as a display manner in which only the target object is highlighted, or a display manner in which the other objects except for the target object are grayed out.

According to the second aspect, the display manner is made different between the target object and the other objects as a presence/absence indication, and therefore, it is possible to visually easily present an operation for displaying a description message.

A third aspect is a storage medium according to the first aspect, wherein the first displayer includes a mark displayer which displays a mark with respect to the target object about which the description message is stored, and the first determiner determines whether or not the input designates the mark.

In the third aspect, the first displayer displays a mark such as a “?” cursor used in this embodiment, for example, and the user inputs so as to designate the mark when he or she wants to display the description message of the target object.

According to the third aspect, a mark is displayed as a presence/absence indication, and therefore, it is possible to visually easily present an operation for displaying a description message.

A fourth aspect is a storage medium according to the third aspect, wherein the mark displayer displays the mark near the corresponding target object.

According to the fourth aspect, it is possible to easily grasp the corresponding relationship between the mark and the target object.

A fifth aspect is a storage medium according to the third aspect, wherein the information processing program causes the processor to further function as: a third determiner which determines whether or not the input accepted from the inputter designates any one of the objects, and an executor which executes, when the third determiner determines that any one of the objects is designated, processing on the object.

In the fifth aspect, if the mark is designated by the inputter, the second displayer displays the description message, and if the object itself is designated by the inputter, processing with respect to the object is executed by the executor.

According to the fifth aspect, by designating the mark before designating the object, the user can view the description message of the content and/or the function of the object in advance, capable of performing a precise designation on the object.

A sixth aspect is a storage medium according to the first aspect, wherein the information processing program causes the processor to further function as a display manner changer which changes a display manner of at least the target object when the first determiner determines that the input accepted from the inputter designates the target object in association with any one of the presence indications.

In the sixth aspect, a display manner changer changes the display manner of the target object by highlighting the target object, for example.

According to the sixth aspect, it is possible to easily perceive which target object the description message that is being displayed corresponds to.

A seventh aspect is a storage medium according to the first aspect, wherein the information processing program causes the processor to further function as a second determiner which determines whether or not there is a predetermined input from the inputter in a state that the presence/absence indication is displayed by the first displayer, and a presence/absence indication eraser which erases the presence/absence indication when the second determiner determines that there is a predetermined input.

In the seventh aspect, a second determiner determines whether or not there is a predetermined input from the inputter (operation of the close key, for example) in a state that the presence/absence indication is displayed by the first displayer. When the second determiner determines that there is a predetermined input, a presence/absence indication eraser erases the presence/absence indication (mark or different display manner).

According to the seventh aspect, the user can freely select the display/nondisplay of the presence/absence indication.

An eighth aspect is a storage medium according to the first aspect, wherein the first displayer displays the presence indication as to each of all the objects about which a description message is prepared.

According to the eighth aspect, it is possible to easily distinguish between the object about which the description message is displayable and the object about which the description message is not displayable.

A ninth aspect is a storage medium according to the first aspect, wherein the information processing apparatus has a first display portion and a second display portion, the target object is displayed on the first display portion, the first displayer displays the presence/absence indication on the first display portion, and the second displayer displays the description message on the second display portion.

According to the ninth aspect, it is possible to display the description message without interrupting the display of the screen including the target objects and the presence/absence indications.

A tenth aspect is a storage medium according to the first aspect, wherein the information processing apparatus has a touch panel, and the inputter includes a touch detector which detects touch coordinates detected by a touch of the touch panel.

According to the tenth aspect, an intuitive operation can be implemented.

An eleventh aspect is an information processing apparatus, comprising: a storage which stores a description message of at least one object; a first displayer which displays a presence/absence indication for indicating whether or not there is a description message for each object when a predetermined input is accepted from an inputter; a determiner which determines whether or not the input accepted from the inputter designates a target object in association with any one of the presence indications; and a second displayer which reads a relevant description message from the storage and displays the same on the screen when the determiner determines that the target object in association with any one of the presence indications is designated.

According to the eleventh aspect, it is possible to expect an advantage similar to the first aspect.

A twelfth aspect is an information processing method of an information processing apparatus that displays a plurality of objects on a screen of a monitor and has a storage storing a description message of at least one object, including following steps of: a first displaying step for displaying a presence/absence indication for indicating whether or not there is a description message for each object when a predetermined input is accepted from an inputter; a determining step for determining whether or not the input accepted from the inputter designates a target object in association with any one of the presence indications; and a second displaying step for reading a relevant description message from the storage and displaying the same on the screen when the determining step determines that the target object in association with any one of the presence indications is designated.

According to the twelfth aspect, it is possible to expect an advantage similar to the first aspect.

A thirteenth aspect is an information processing system displaying a plurality of objects on a screen of a monitor, comprising: a storage which stores a description message of at least one object; a first displayer which displays a presence/absence indication for indicating whether or not there is a description message for each object when a predetermined input is accepted from an inputter; a determiner which determines whether or not the input accepted from the inputter designates a target object in association with any one of the presence indications; and a second displayer which reads a relevant description message from the storage and displays the same on the screen when the determiner determines that the target object in association with any one of the presence indications is designated.

According to the thirteenth aspect, it is possible to expect an advantage similar to the first aspect.

According to the present invention, in accordance with an input by the user, the presence or absence of the description message is displayed for each object, and therefore, it is possible to easily grasp the object capable of displaying the description message.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one embodiment of an external configuration of a game apparatus of one embodiment of this invention.

FIG. 2 is an illustrative view showing a top view and a left side view showing the game apparatus shown in FIG. 1 in a folded manner.

FIG. 3 is a block diagram showing an electric configuration of the game apparatus shown in FIG. 1 and FIG. 2.

FIG. 4 is an illustrative view showing a memory map of a main memory shown in FIG. 3.

FIG. 5 is an illustrative view showing one example of game screens in this embodiment.

FIG. 6 is an illustrative view showing one example of display screens when a transition is made from the game screens shown in FIG. 5 to a help mode.

FIG. 7 is an illustrative view showing one example of display screens displaying a description message in the help mode in FIG. 6.

FIG. 8 is a flowchart showing one example of an operation of game processing in the embodiment.

FIG. 9 is a flowchart showing one example of an operation of the help mode, etc. to be executed when a touch input is detected in the embodiment.

### DETAILED DESCRIPTION OF THE PREFERRED EMBODIMENTS

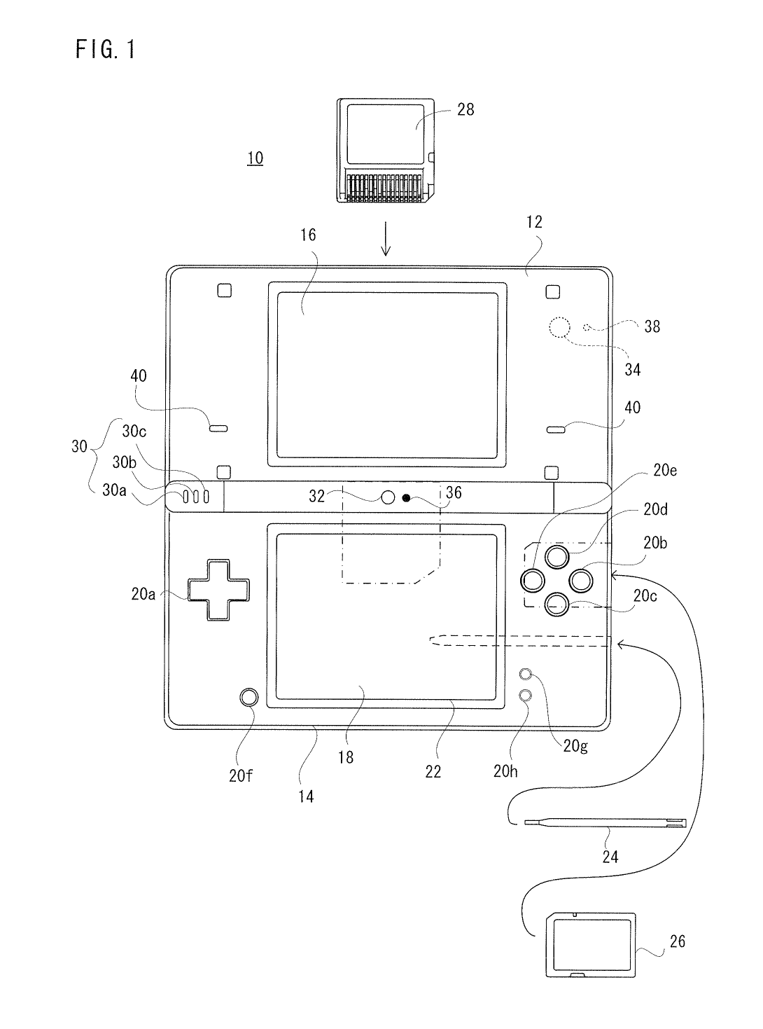

Referring to FIG. 1, a game apparatus 10 of one embodiment of the present invention includes an upper housing 12 and a lower housing 14, and the upper housing 12 and the lower housing 14 are connected with each other so as to be opened or closed (foldable). In FIG. 1 example, the upper housing 12 and the lower housing 14 are constructed in the form of a horizontally long rectangular plate, and are rotatably connected with each other at the long sides of both of the housings. That is, the game apparatus 10 of this embodiment is a folding hand-held game apparatus, and in FIG. 1, the game apparatus 10 is shown in an opened state (in an open state). The game apparatus 10 is constructed such a size that the user can hold with both hands or one hand even in the open state

Generally, the user uses the game apparatus 10 in the open state. Furthermore, the user keeps the game apparatus 10 in a close state when not using the game apparatus 10. Here, the game apparatus 10 can maintain an opening and closing angle formed between the upper housing 12 and the lower housing 14 at an arbitrary angle between the close state and open state by a friction force, etc. exerted at the connected portion as well as the aforementioned close state and open state. That is, the upper housing 12 can be fixed with respect to the lower housing 14 at the arbitrary angle.

Additionally, the game apparatus 10 is mounted with cameras (32, 34) described later, functioning as an imaging device, such as imaging an image with the cameras (32, 34), displaying the imaged image on the screen, and saving the imaged image data.

As shown in FIG. 1, the upper housing 12 is provided with a first LCD 16, and the lower housing 14 is provided with a second LCD 18. The first LCD 16 and the second LCD 18 take a horizontally-long shape, and are arranged such that the directions of the long sides thereof are coincident with the long sides of the upper housing 12 and the lower housing 14. For example, resolutions of the first LCD 16 and the second LCD 18 are set to 256 (horizontal)×192 (vertical) pixels (dots). Here, both of the LCDs may not be the same in size, and may have different vertical and/or horizontal lengths from each other.

In addition, although an LCD is utilized as a display in this embodiment, an EL (Electronic Luminescence) display, a plasmatic display, etc. may be used in place of the LCD. Furthermore, the game apparatus 10 can utilize a display with an arbitrary resolution.

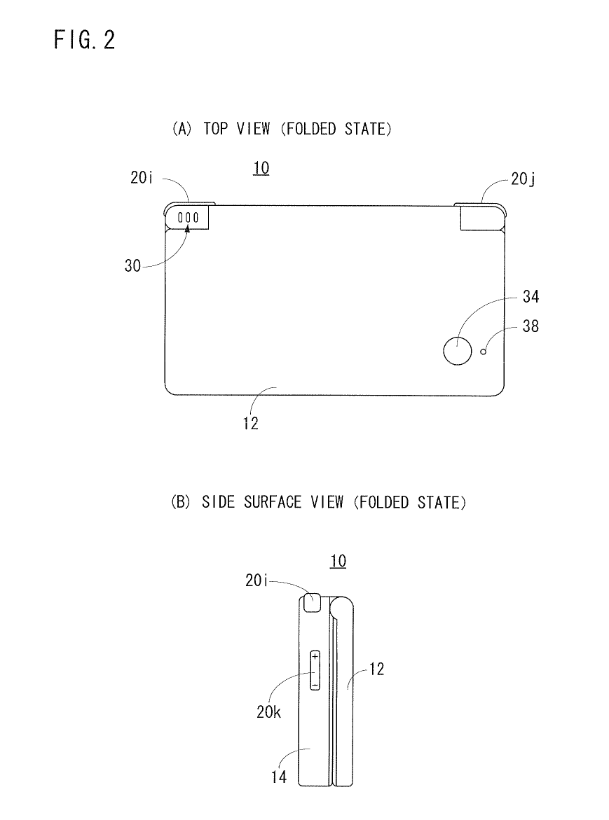

As shown in FIG. 1 and FIG. 2, the lower housing 14 is provided with respective operation buttons 20a-20k as input devices. Out of the respective operation buttons 20a-20k, the direction input button 20a, the operation button 20b, the operation button 20c, the operation button 20d, the operation button 20e, the power button 20f, the start button 20g, and the select button 20h are provided on the surface (inward surface) to which the second LCD 18 of the lower housing 14 is set, More specifically, the direction input button 20a and the power button 20f are arranged at the left of the second LCD 18, and the operation buttons 20b-20e, 20g and 20h are arranged at the right of the second LCD 18. Furthermore, when the upper housing 12 and the lower housing 14 are folded, the operation buttons 20a-20h are enclosed within the game apparatus 10.

The direction input button (cross key) 20a functions as a digital joystick, and is used for instructing a moving direction of a player object, moving a cursor, and so forth. Each operation buttons 20b-20e is a push button, and is used for causing the player object to make an arbitrary action, executing a decision and cancellation, and so forth. The power button 20f is a push button, and is used for turning on or off the main power supply of the game apparatus 10. The start button 20g is a push button, and is used for temporarily stopping (pausing), starting (restarting) a game, and so forth. The select button 20h is a push button, and is used for a game mode selection, a menu selection, etc.

Although operation buttons 20i-20k are omitted in FIG. 1, as shown in FIG. 2(A), the operation button (L button) 20i is provided at the left corner of the upper side surface of the lower housing 14, and the operation button (R button) 20j is provided at the right corner of the upper side surface of the lower housing 14. Furthermore, as shown in FIG. 2(B), the volume button 20k is provided on the left side surface of the lower housing 14.

FIG. 2(A) is an illustrative view of the game apparatus 10 in a folded manner as seen from a top surface (upper housing 12). FIG. 2(B) is an illustrative view of the game apparatus 10 in a folded manner when seen from a left side surface.

The L button 20i and the R button 20j are push buttons, and can be used for similar operations to those of the operation buttons 20b-20e, and can be used as subsidiary operations of these operation buttons 20b-20e. Furthermore, in this embodiment, the L button 20i and the R button 20j can be also used for an operation of an imaging instruction (shutter operation). The volume button 20k is made up of two push buttons, and is utilized for adjusting the volume of the sound output from two speakers (right speaker and left speaker) not shown. In this embodiment, the volume button 20k is provided with an operating portion including two push portions, and the aforementioned push buttons are provided by being brought into correspondence with the respective push portions. Thus, when the one push portion is pushed, the volume is made high, and when the other push portion is pushed, the volume is made low. For example, when the push portion is hold down, the volume is gradually made high, or the volume is gradually made low.

Returning to FIG. 1, the game apparatus 10 is further provided with a touch panel 22 as an input device separate from the operation buttons 20a-20k. The touch panel 22 is attached so as to cover the screen of the second LCD 18. In this embodiment, a touch panel of a resistance film system is used as the touch panel 22, for example. However, the touch panel 22 can employ an arbitrary capacitive touch panel without being restricted to the resistance film system. Furthermore, in this embodiment, as the touch panel 22, a touch panel having the same resolution (detection accuracy) as the resolution of the second LCD 18, for example, is utilized. However, the resolution of the touch panel 22 and the resolution of the second LCD 18 are not necessarily coincident with each other.

Additionally, at the right side surface of the lower housing 14, a loading slot (represented by a dashed line shown in FIG. 1) is provided. The loading slot can house a touch pen 24 to be utilized for performing an operation on the touch panel 22. Generally, an input with respect to the touch panel 22 is performed with the touch pen 24, but it may be performed with a finger of the user beyond the touch pen 24. Accordingly, in a case that the touch pen 24 is not to be utilized, the loading slot and the housing portion for the touch pen 24 need not be provided.

Moreover, on the right side surface of the lower housing 14, a loading slot for housing a memory card 26 (represented by a chain double-dashed line in FIG. 1) is provided. Inside of the loading slot, a connector (not illustrated) for electrically connecting the game apparatus 10 and the memory card 26 is provided. The memory card 26 is an SD card, for example, and detachably attached to the connector. This memory card 26 is used for storing (saving) an image imaged by the game apparatus 10, and reading the image generated (imaged) or stored by another apparatus in the game apparatus 10.

In addition, on the upper side surface of the lower housing 14, a loading slot (represented by an alternate long and short dash line FIG. 1) for housing a memory card 28 is provided. Inside the loading slot as well, a connector (not illustrated) for electrically connecting the game apparatus 10 and the memory card 28 is provided. The memory card 28 is a recording medium of recording an information processing program such as game processing, necessary data, etc. and is detachably attached to the loading slot provided to the lower housing 14.

At the left end of the connected portion (hinge) between the upper housing 12 and the lower housing 14, an indicator 30 is provided. The indicator 30 is made up of three LEDs 30a, 30b, 30c. Here, the game apparatus 10 can make a wireless communication with another appliance, and the first LED 30a lights up when a wireless communication with the appliance is established. The second LED 30b lights up while the game apparatus 10 is recharged. The third LED 30c lights up when the main power supply of the game apparatus 10 is turned on. Thus, by the indicator 30 (LEDs 30a-30c), it is possible to inform the user of a communication-established state, a charge state, and a main power supply on/off state of the game apparatus 10.

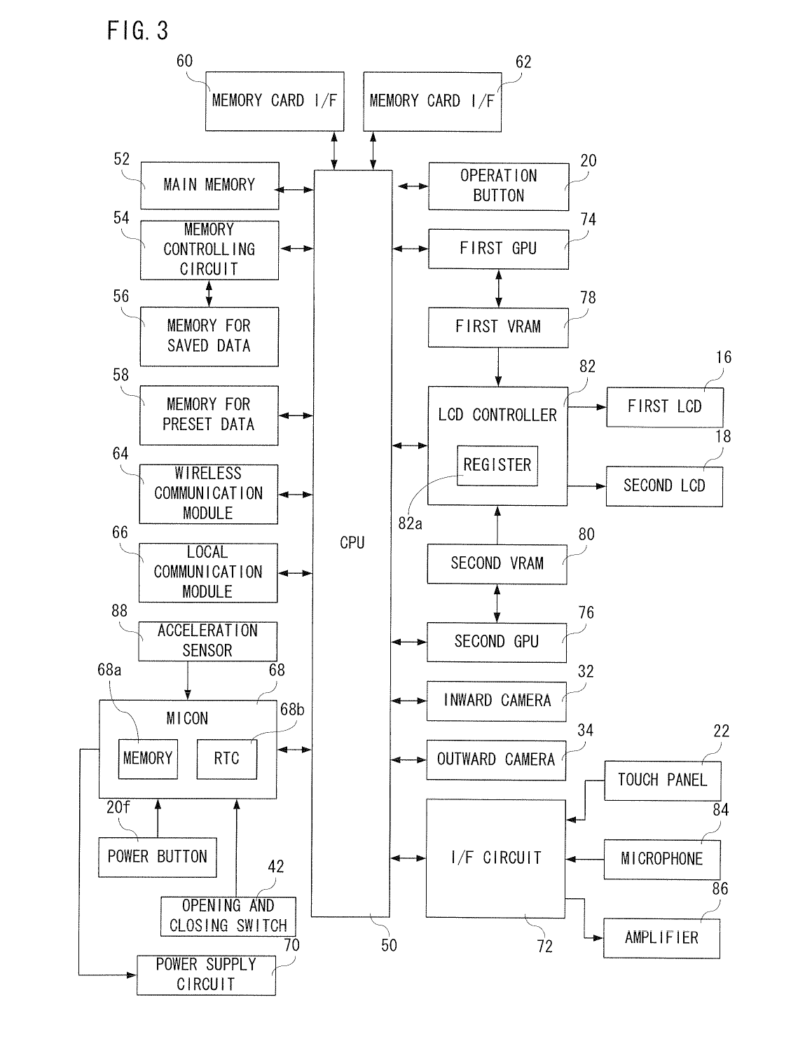

Although illustration is omitted, a switch (opening and closing switch 42: see FIG. 3) that is switched in response to opening and closing of the game apparatus 10 is provided inside the hinge. For example, the opening and closing switch 42 is turned on when that the game apparatus 10 is in an opened state. On the other hand, the opening and closing switch 42 is turned off when that the game apparatus 10 is in a closed (folded) state. Here, it is only necessary to find that the game apparatus 10 is in the opened state or the closed state, and therefore, the turning on and off of the opening and closing switch 42 may be reversed.

As described above, the upper housing 12 is provided with the first LCD 16. In this embodiment, the touch panel 22 is set so as to cover the second LCD 18, but the touch panel 22 may be set so as to cover the first LCD 16. Alternatively, two touch panels 22 may be set so as to cover the first LCD 16 and the second LCD 18.

Additionally, the upper housing 12 is provided with the two cameras (inward camera 32 and outward camera 34). As shown in FIG. 1, the inward camera 32 is attached in the vicinity of the connected portion between the upper housing 12 and the lower housing 14 and on the surface to which the first LCD 16 is provided such that the display surface of the first LCD 16 and the imaging surface are in parallel with each other or are leveled off. On the other hand, the outward camera 34 is attached to the surface being opposed to the surface to which the inward camera 32 is provided as shown in FIG. 2(A), that is, on the outer surface of the upper housing 12 (the surface turns to the outside when the game apparatus 10 is in a close state, and on the back surface of the upper housing 12 shown in FIG. 1). Here, in FIG. 1, the outward camera 34 is shown by a dashed line.

Additionally, on the internal surface near the aforementioned connected portion, a microphone 84 (see FIG. 3) is housed as a voice input device. Then, on the internal surface near the aforementioned connected portion, a through hole 36 for the microphone 84 is formed so as to detect a sound outside the game apparatus 10. The position for housing the microphone 84 and the position of the through hole 36 for the microphone 84 are not necessarily on the aforementioned connected portion, and the microphone 84 may be housed in the lower housing 14, and the through hole 36 for the microphone 84 may be provided to the lower housing 14 in correspondence with the housing position of the microphone 84.

Furthermore, on the outer surface of the upper housing 12, in the vicinity of the outward camera 34, a fourth LED 38 (dashed line in FIG. 1) is attached. The fourth LED 38 lights up at a time when an imaging is made with the inward camera 32 or the outward camera 34 (shutter button is pushed). Furthermore, in a case that a motion image is imaged with the inward camera 32 or the outward camera 34, the fourth LED 38 continues to light up during the imaging. That is, by making the fourth LED 38 light up, it is possible to inform an object to be imaged or his or her surrounding that an imaging with the game apparatus 10 is made (is being made).

Moreover, the upper housing 12 is formed with a sound release hole 40 on both sides of the first LCD 16. The above-described speaker is housed at a position corresponding to the sound release hole 40 inside the upper housing 12. The sound release hole 40 is a through hole for releasing the sound from the speaker to the outside of the game apparatus 10.

FIG. 3 is a block diagram showing an electric configuration of the game apparatus 10 of this embodiment. As shown in FIG. 3, the game apparatus 10 includes electronic components, such as a CPU 50, a main memory 52, a memory controlling circuit 54, a memory for saved data 56, a memory for preset data 58, a memory card interface (memory card I/F) 60, a memory card I/F 62, a wireless communication module 64, a local communication module 66, a micron 68, a power supply circuit 70, an interface circuit (I/F circuit) 72, a first GPU (Graphics Processing Unit) 74, a second GPU 76, a first VRAM (Video RAM) 78, a second VRAM 80, an LCD controller 82, etc. These electronic components (circuit components) are mounted on an electronic circuit board, and housed in the lower housing 14 (or the upper housing 12 may also be appropriate).

The CPU 50 is a game processing means or an information processing means for executing a predetermined program. In this embodiment, the predetermined program is stored in a memory (memory for saved data 56, for example) within the game apparatus 10 and the memory card 26 and/or 28, and the CPU 50 executes information processing described later by executing the predetermined program.

Here, the program to be executed by the CPU 50 may previously be stored in the memory within the game apparatus 10, acquired from the memory card 26 and/or 28, and acquired from another appliance by communicating with this another appliance.

The CPU 50 is connected with the main memory 52, the memory controlling circuit 54, and the memory for preset data 58. The memory controlling circuit 54 is connected with the memory for saved data 56. The main memory 52 is a memory means to be utilized as a work area and a buffer area of the CPU 50. That is, the main memory 52 stores (temporarily stores) various data to be utilized in the aforementioned game processing and information processing, and stores a program from the outside (memory cards 26 and 28, and another appliance). In this embodiment, as a main memory 52, a PSRAM (Pseudo-SRAM) is used, for example. The memory for saved data 56 is a memory means for storing (saving) a program to be executed by the CPU 50, data of an image imaged by the inward camera 32 and the outward camera 34, etc. The memory for saved data 56 is constructed by a nonvolatile storage medium, and can utilize a NAND type flash memory, for example. The memory controlling circuit 54 controls reading and writing from and to the memory for saved data 56 according to an instruction from the CPU 50. The memory for preset data 58 is a memory means for storing data (preset data), such as various parameters, etc. which are previously set in the game apparatus 10. As a memory for preset data 58, a flash memory to be connected to the CPU 50 through an SPI (Serial Peripheral Interface) bus can be used.

Both of the memory card I/Fs 60 and 62 are connected to the CPU 50. The memory card I/F 60 performs reading and writing data from and to the memory card 26 attached to the connector according to an instruction form the CPU 50. Furthermore, the memory card I/F 62 performs reading and writing data from and to the memory card 28 attached to the connector according to an instruction form the CPU 50. In this embodiment, image data corresponding to the image imaged by the inward camera 32 and the outward camera 34 and image data received by other devices are written to the memory card 26, and the image data stored in the memory card 26 is read from the memory card 26 and stored in the memory for saved data 56, and sent to other devices. Furthermore, the various programs stored in the memory card 28 is read by the CPU 50 so as to be executed.

Here, the information processing program such as a game program is not only supplied to the game apparatus 10 through the external storage medium, such as a memory card 28, etc. but also is supplied to the game apparatus 10 through a wired or a wireless communication line. In addition, the information processing program may be recorded in advance in a nonvolatile storage device inside the game apparatus 10. Additionally, as an information storage medium for storing the information processing program, an optical disk storage medium, such as a CD-ROM, a DVD or the like may be appropriate beyond the aforementioned nonvolatile storage device.

The wireless communication module 64 has a function of connecting to a wireless LAN according to an IEEE802.11.b/g standard-based system, for example. The local communication module 66 has a function of performing a wireless communication with the same types of the game apparatuses by a predetermined communication system. The wireless communication module 64 and the local communication module 66 are connected to the CPU 50. The CPU 50 can receive and send data over the Internet with other appliances by means of the wireless communication module 64, and can receive and send data with the same types of other game apparatuses by means of the local communication module 66.

Furthermore, the CPU 50 is connected with the micron 68. The micron 68 includes a memory 68a and an RTC 68b. The memory 68a is a RAM, for example, and stores a program and data for a control by the micron 68. The RTC 68b counts a time. In the micron 68, date and a current time, etc. can be calculated on the basis of the time counted by the RTC 68b.

The micron 68 is connected with the power button 20f, the opening and closing switch 42, the power supply circuit 70, and the acceleration sensor 88. A power-on signal is given to the micron 68 from the power button 20f. When the power button 20f is turned on in a state that the main power supply of the game apparatus 10 is turned off, the memory 68a functioning as a BootROM of the micron 68 is activated to perform a power control in response to opening and closing of the game apparatus 10 as described above. On the other hand, when the power button 20f is turned on in a state that the main power supply of the game apparatus 10 is turned on, the micron 68 instructs the power supply circuit 70 to stop supplying power to all the circuit components (except for the micron 68). Here, the power supply circuit 70 controls the power supplied from the power supply (typically, a battery housed in the lower housing 14) of the game apparatus 10 to supply power to the respective circuit components of the game apparatus 10.

Furthermore, from an opening and closing switch 42, a power-on signal or a power-off signal is applied to the micron 68. In a case that the main power supply of the game apparatus 10 is turned on in a state that the opening and closing switch 42 is turned on (the main body of the game apparatus 10 is in an opened state), a mode in which a power is supplied from the power supply circuit 70 to all the circuit components of the game apparatus 10 under the control of the micron 68 (hereinafter referred to as “normal mode”) is set. In the normal mode, the game apparatus 10 can execute an arbitrary application, and is in use (using state) by a user or a player (hereinafter referred to as “player”).

Additionally, in a case that the opening and closing switch 42 is turned off in a state that the power supply of the game apparatus 10 is turned on (the main body of the game apparatus 10 is in a closed state), a mode in which a power is supplied from the power supply circuit 70 to a part of the components of the game apparatus 10 (hereinafter referred to as “sleep mode”) is set. In the sleep mode, the game apparatus 10 cannot execute an arbitrary application, and is a state that the player is not in use (non using state). In this embodiment, the part of the components is the CPU 50, the wireless communication module 64, and the micron 68. Here, in the sleep mode (sleep state), the CPU 50 is basically in a state that a clock is stopped (inactivated), resulting in less power consumption. Additionally, in the sleep mode, a power supply to the CPU 50 may be stopped. Accordingly, as described above, in this embodiment, in the sleep mode, an application is never executed by the CPU 50.

In addition, when the sleep state is canceled (non-sleep state) due to the game apparatus 10 being opened, and so forth, a power-off signal is input to the micron 68 from the opening and closing switch 42. Thus, the micron 68 activates the CPU 50 to notify the CPU 50 of the cancelation of the sleep state. In response thereto, the CPU 50 instructs the micron 68 to cancel the sleep state. That is, under the instruction from the CPU 50, the micron 68 controls the power supply circuit 70 to start supplying power to all the circuit components. Thus, the game apparatus 10 makes a transition to the normal mode to enter the using state.

Moreover, as described above, the micron 68 is connected with the acceleration sensor 88. For example, the acceleration sensor 88 is a three-axis acceleration sensor, and provided inside the lower housing 14 (the upper housing 12 may be possible). This detects an acceleration in a direction vertical to the surface of the first LCD 16 (second LCD 18) of the game apparatus 10, and accelerations in two crosswise directions (longitudinal and laterally) that are parallel to the first LCD 16 (second LCD 18). The acceleration sensor 88 outputs a signal as to the detected acceleration (acceleration signal) to the micron 68. The micron 68 can detect a direction of the game apparatus 10, and a magnitude of the shake of the game apparatus 10 on the basis of the acceleration signal. Accordingly, it is possible to make the micron 68 and the acceleration sensor 88 function as a pedometer, for example. The pedometer using the acceleration sensor 88 is already known, and therefore, the detailed content is omitted, but the step counts are measured in correspondence with the magnitude of the acceleration.

Also, the game apparatus 10 includes the microphone 84 and an amplifier 86. Both of the microphone 84 and the amplifier 86 are connected to the I/F circuit 72. The microphone 84 detects a voice and a sound (clap and handciap, etc.) of the user produced or generated toward the game apparatus 10, and outputs a sound signal indicating the voice or the sound to the I/F circuit 72. The amplifier 86 amplifies the sound signal applied from the I/F circuit 72, and applies the amplified signal to the speaker (not illustrated). The I/F circuit 72 is connected to the CPU 50.

The touch panel 22 is connected to the I/F circuit 72. The I/F circuit 72 includes a sound controlling circuit for controlling the microphone 84 and the amplifier 86 (speaker), and a touch panel controlling circuit for controlling the touch panel 22. The sound controlling circuit performs an A/D conversion and a D/A conversion on a sound signal, or converts a sound signal into sound data in a predetermined format. The touch panel controlling circuit generates touch position data in a predetermined format on the basis of a signal from the touch panel 22 and outputs the same to the CPU 50. For example, the touch position data is data indicating coordinates of a position where an input is performed on an input surface of the touch panel 22.

Additionally, the touch panel controlling circuit performs reading of a signal from the touch panel 22 and generation of the touch position data per each predetermined time. By fetching the touch position data via the I/F circuit 72, the CPU 50 can know the position on the touch panel 22 where an input is made.

The operation button 20 is made up of the aforementioned respective operation buttons 20a-20k (except for the power switch 22f. This hold true for the following), and is connected to the CPU 50. The operation data indicating an input state (whether or not to be pushed) with respect to each of the operation buttons 20a-20k is output from the operation button 20 to the CPU 50. The CPU 50 acquires the operation data from the operation button 20, and executes processing according to the acquired operation data.

Both of the inward camera 32 and the outward camera 34 are connected to the CPU 50. The inward camera 32 and the outward camera 34 image images according to instructions from the CPU 50, and output image data corresponding to the imaged images to the CPU 50. In this embodiment, the CPU 50 issues an imaging instruction to any one of the inward camera 32 and the outward camera 34 while the camera (32, 34) which has received the imaging instruction images an image and transmits the image data to the CPU 50.

The first GPU 74 is connected with the first VRAM 78, and the second GPU 76 is connected with the second VRAM 80. The first GPU 74 generates a first display image on the basis of data for generating the display image stored in the main memory 52 according to an instruction from the CPU 50, and draws the same in the first VRAM 78. The second GPU 76 similarly generates a second display image according to an instruction form the CPU 50, and draws the same in the second VRAM 80. The first VRAM 78 and the second VRAM 80 are connected to the LCD controller 82.

The LCD controller 82 includes a register 82a. The register 82a stores a value of “0” or “1” according to an instruction from the CPU 50. In a case that the value of the register 82a is “0”, the LCD controller 82 outputs the first display image drawn in the first VRAM 78 to the second LCD 18, and outputs the second display image drawn in the second VRAM 80 to the first LCD 16. Furthermore, in a case that the value of the register 82a is “1”, the LCD controller 82 outputs the first display image drawn in the first VRAM 78 to the first LCD 16, and outputs the second display image drawn in the second VRAM 80 to the second LCD 18.

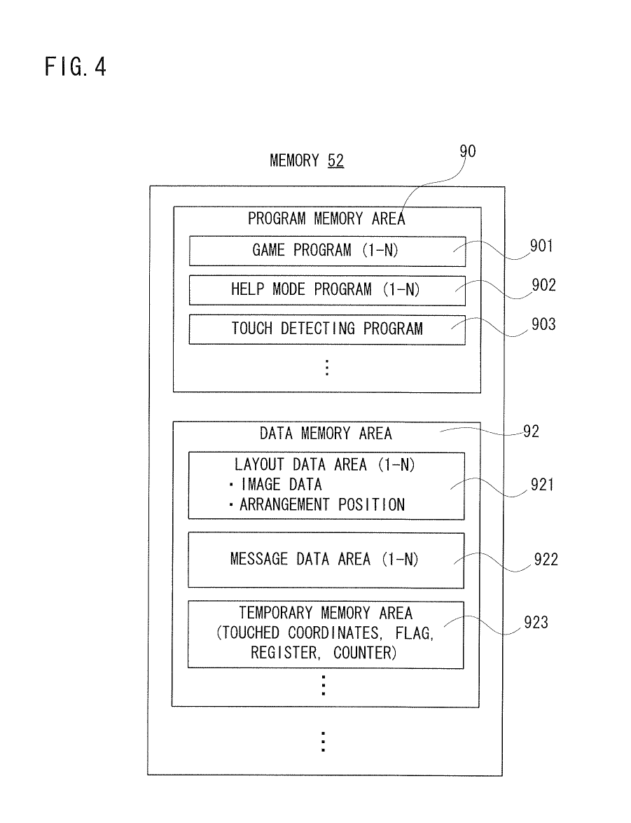

FIG. 4 shows a memory map of the main memory 52. The main memory 52 includes a program area 90 and a data area 92. The program area 90 includes a game program area 901 storing a game program, a help mode program area 901 storing a help mode program, a touch detecting program area 903 storing a touch detecting program, etc. The game program is a program for displaying a game screen including images of a player object and other objects using layout data described later, and controlling a movement of the player object according to an operation input by the user or the player. The help mode program is a program for deciding which description message is displayed with which layout data in a help mode (described later). The help mode program is also a program for determining an association between an object and a description message, and determining the presence or absence of the description message for each object and which description message is relevant on the basis of identification data described later indicating a corresponding relationship between the object and the description message. The touch detecting program is a program for acquiring touched position coordinates on the touch panel 22 by controlling the aforementioned touch panel controlling circuit, and is constructed as a timer interrupt program as described before.

Here, the game screen is generally made up of a plurality of scene screens, and the game program and the help mode program are set for each scene. In FIG. 4, the notation of “(1-N)” shows that the relevant program and data are set for each scene.

The data area 92 includes a layout data area 921 for storing layout data, a message data area 922 for storing message data, a temporary memory area 923, etc. The layout data and the message data are set for each scene as described above.

The layout data includes image data of images of objects, icons, etc. to be displayed on each scene (hereinafter, all the object displayed on the screen may collectively be referred to as “object”.) and positional data for indicating at which position each of these images is to be displayed. The message data is text data for displaying a description message in the help mode. Here, the description message may include images as well as texts. In this case, in this message data, image data of an image for message is sometimes set as well as the text data. Or, the description message may include only images. In the message data, positional data for indicating at which position of the screen such a description message is to be displayed is further included. Furthermore, in either one of the layout data and the message data or both of them, identification data (label number, etc.) indicating a corresponding relationship between each of the images (objects) and the description message is included. Here, the positional data for indicating at which position of the screen such a description message is to be displayed may be included in the layout data.

Here, the image data that can be commonly used among the respective scenes can be collectively stored as common layout data, and even the common image data can be set as layout data for each scene.

The temporary memory area 923 not only temporarily stores data of touched coordinates indicating a touched position detected by the above-described touch detecting program 903, but also includes a flag area for storing flag data, for example, a help mode flag, etc., a counter area utilized as a counter, a register area utilized as a register, etc. As a counter, there is a timer counter for measuring a lapse of time.

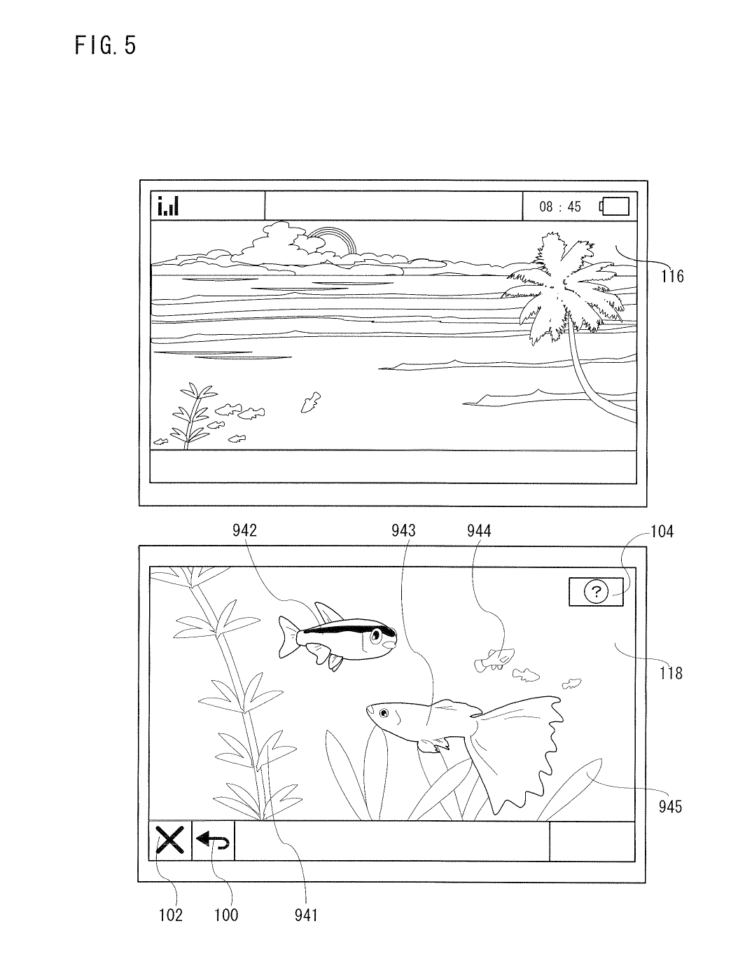

In this embodiment, the help mode is set according to a procedure shown in FIG. 5 to FIG. 7, and in the help mode, description messages describing contents and/or functions of one, or any one or all of the two or more objects that are displayed on the game screen are displayed.

As shown in FIG. 5, a game screen in one scene of a game that can be executed in the hand-held game apparatus 10, for example, is displayed on the first LCD 16 and the second LCD 18. In the game screen of the second LCD 18, a plurality of objects 941, 942, 943, . . . are included. In FIG. 5, on the second LCD 18, two soft keys 100 and 102 are further arranged along a bottom side. The soft key 100 is a return key for returning to a preceding page or a preceding operation state. At the lower left corner, a close key 102 in which “×” (cross sign) is displayed is set. The close key 102 is a key for issuing a command of ending (closing) the help mode and returning to the normal game screen. At the upper right corner of the second LCD 18, soft key 104 in which an encircled “?” is displayed is displayed. The soft key 104 is a help mode key for making a transition to the “help mode” for describing the contents and/or functions of the objects 941, 942, 943, . . . displayed on the second LCD 18.

Here, the image data and display position of each of the soft keys 100 to 104 is set as layout data for each scene.

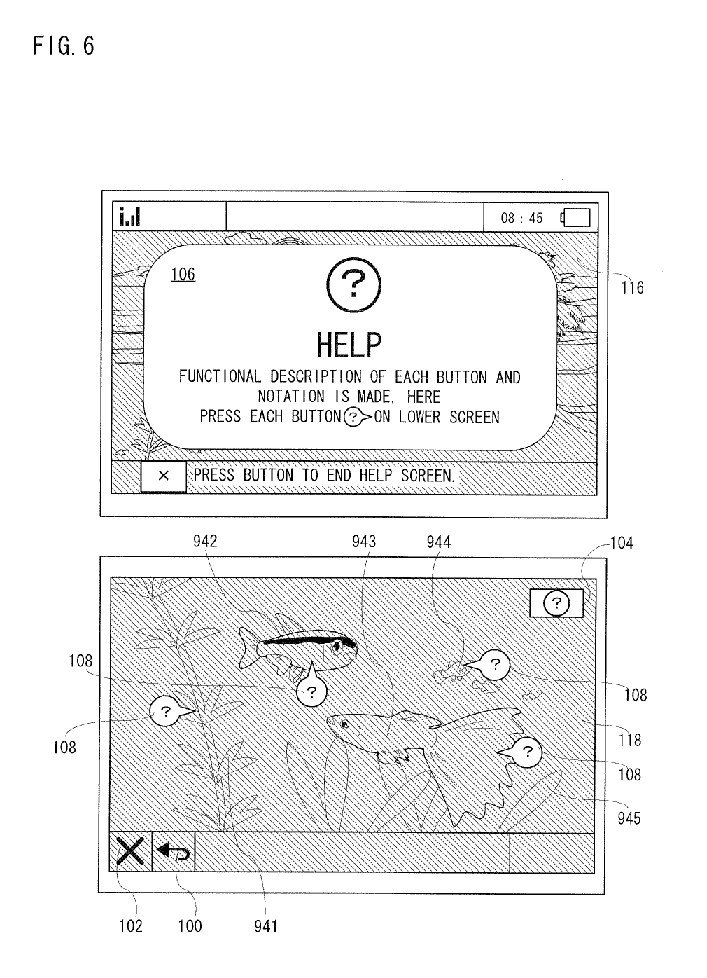

When the help mode key 104 is touched in the display state of the game screen in FIG. 5, screens in the help mode shown in FIG. 6 are displayed on the first and second LCDs 16 and 18.

In the display example in FIG. 6, on the first LCD 16, a display screen 106 for informing the user of a transition to the help mode, and displaying a description message of an operation method in the help mode is displayed to be overlaid on the image of the game screen in the one scene of the game displayed in FIG. 5. As a specific description message, “FUNCTIONAL DESCRIPTION OF EACH BUTTON AND NOTATION IS MADE, HERE” and “PRESS EACH BUTTON (?) ON LOWER SCREEN” are displayed. Here, the (?) means a design of a speech balloon with ? mark, and is called a “? cursor”. The “?” cursor 108 is displayed near a target object on the lower screen, that is, a first display portion, that is, the second LCD 18, and is for instructing the user that the description message about the object indicated by the “?” cursor 108 is displayable. That is, the “?” cursor 108 functions as a means to show a user which object can display the description message in the help mode. In other words, the “?” cursor 108 functions as a presence/absence indication for indicating whether or not a description message is prepared for each object, and the display of the “?” cursor 108 means a “presence indication”. Thus, if the presence/absence indication of the description message is displayed for each object as a mark like the “?” cursor 108, an operation for displaying the description message can be visually and easily displayed. By displaying the mark such as the “?” cursor 108 near the target object, a corresponding relationship between the mark and the object can be easily grasped. On the other hand, as to the object about which the description message is not prepared (message data is not stored), the mark such as the “?” cursor 108 is not displayed.

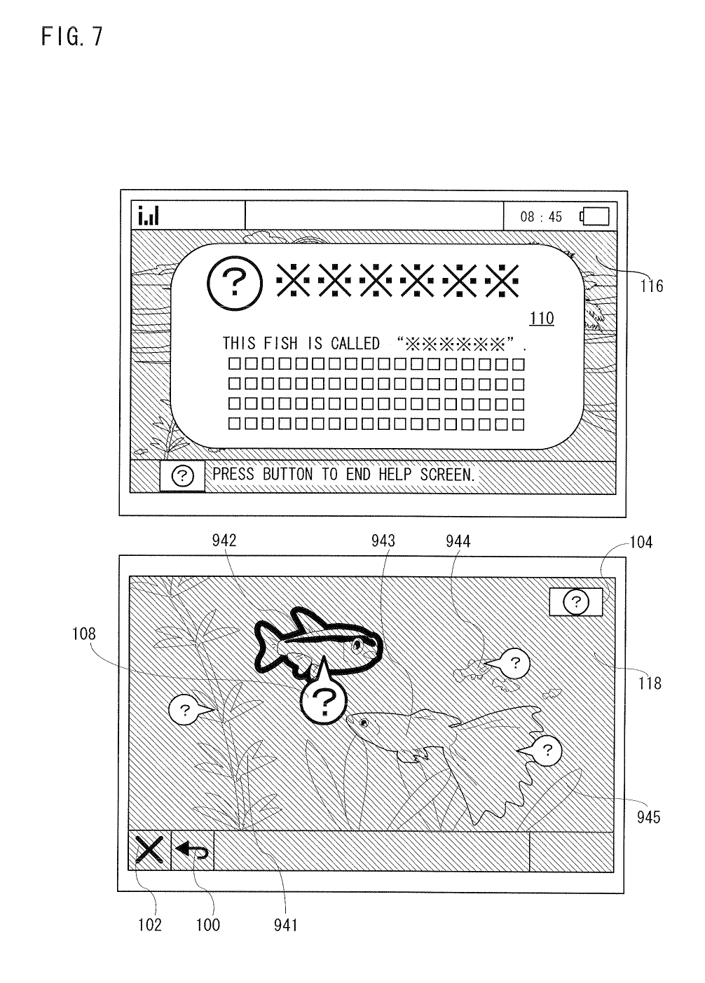

Then, when the “?” cursor 108 is touched in the help mode, the detailed explanation of the object indicated by the touched “?” cursor 108 is displayed on the upper screen, that is, a second display portion, that is, the first LCD 16 (FIG. 7) as a description message. That is, by designating the “?” cursor 108, the object in association with the “?” cursor 108 is selected or designated as a result.

In the display example in FIG. 6, at a start of a transition to the help mode, the entire second LCD 18 including the “?” cursors 108 is grayed out (displayed entirely lightly with a gray panel overlaid). Then, in the help mode shown in FIG. 6, the color of the help mode key 104 displayed on the second LCD 18 changes from the color in FIG. 5. In FIG. 5, the help mode key 104 is displayed in blue, but in the help mode, this is displayed in yellow. The reason why the color of the help mode key 104 is thus grayed out and so forth is because of clearly informing the user of a transition to the help mode.

When any one of the “?” cursors 108 is touched in the help mode in FIG. 6, a transition to the display in FIG. 7 is made.

The display example in FIG. 7 is a display example when the user touches the “?” cursor 108 indicating the one object 942 out of the three objects 941, 942, 943 that are displayed on the second LCD 18 in the help mode. That is, since the user desires to know the details of the object 942, he or she is touching the “?” cursor 108 in association with the object 942. In this state, the relevant object 942 and the “?” cursor 108 in association therewith are highlighted, and the rest of the objects are still grayed out. By the changes in the display, the user can easily know the description message of which object is being displayed now. Then, a detailed explanation (description message) 110 of the object 942 is displayed on the first LCD 16.

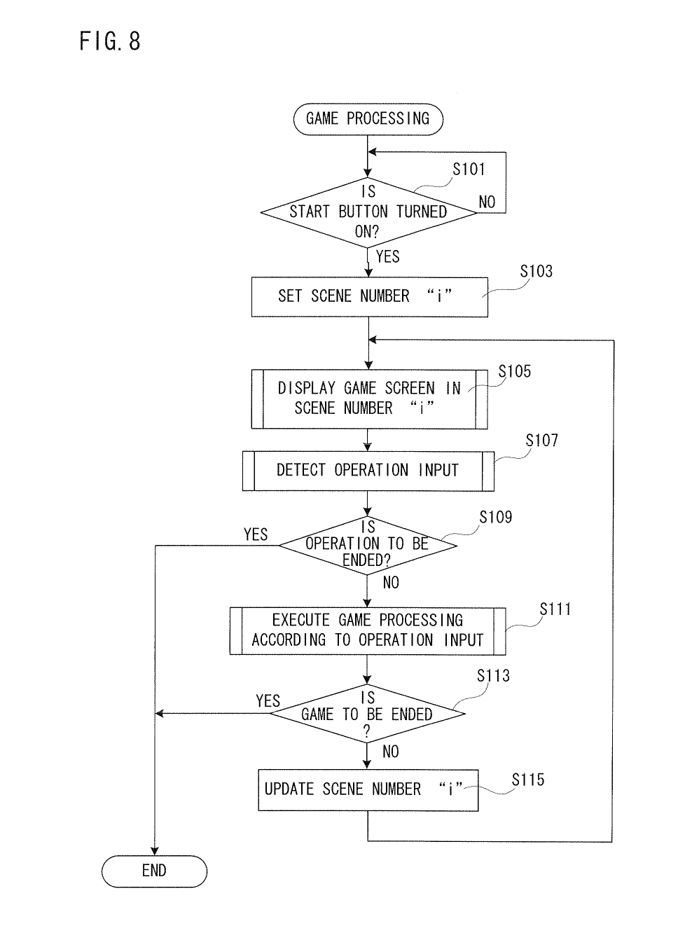

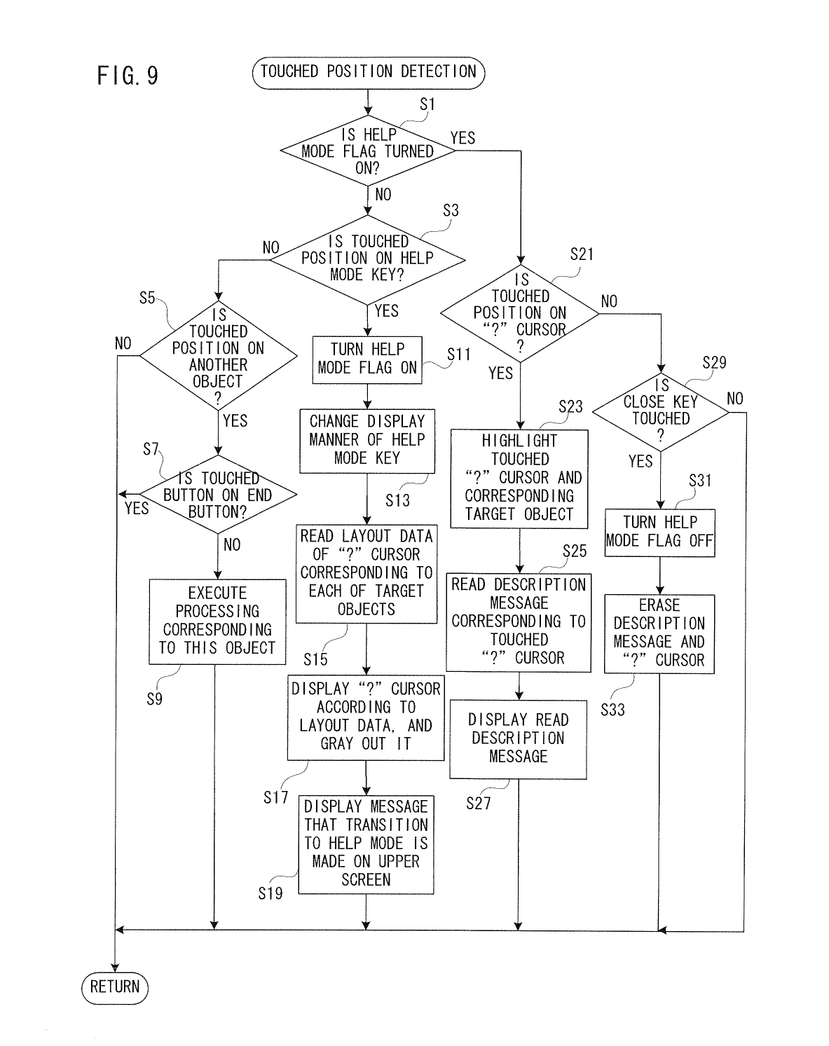

The operation of the help mode is explained by using flowcharts shown in FIG. 8 and FIG. 9.

FIG. 8 is a flowchart showing game processing to be performed by executing the game program. In a first step S 101, the CPU 50 determines whether or not the start button 20g included in the operation button 20 is operated, and if “YES”, a predetermined scene number “i” is set in a next step 5103, and the scene number “i” is loaded into the scene number register (not illustrated) of the temporary memory area 523 (FIG. 4). Here, even immediately after the start button 20g is pressed, the first scene number “i” is not necessarily “1”. In a case of playing the game from the continuation of last time, the scene number sequel to the previous scene is set. Furthermore, depending on the game program, the game may not necessarily start from the scene 1.

Successively, in a next step S105, the CPU 50 executes the game program in a scene N set in the memory 48, and displays a plurality of objects (including all kinds of objects displayed on the screen) as shown in FIG. 5, for example, on the first LCD 16 and the second LCD 18 according to the layout data in the scene N. Here, such a display of the game screen has already been well known, and the detailed description thereof is omitted.

In a succeeding step S107, the CPU 50 detects an operation input from the operation button 20, the touch panel 22, etc. Then, in a next step S109, it is determined whether or not the operation input at that time is for instructing the game end. If “YES” is determined, for example, when the power button 20f is operated or when an end soft key (not illustrated) for instructing the end is touched, the game program is ended as it is.

When “NO” is determined in the step 5109, the CPU 50 executes game processing according to the operation input detected in the step S107 in a step 5111. For example, if the direction input button 20a is operated, the object (player character, cursor, etc.) is moved in a direction designated by the direction input button 20a. Furthermore, if the A button 20b is pressed, the player character is caused to perform a predetermined motion. Here, the operation in the step S111 is well known, and therefore, the detailed explanation thereof is omitted.

In a next step S113, it is determined whether or not the game is to be ended, that is, it is determined whether a game clear or a stage clear or not. If “NO”, the scene number “i” is updated in a step S115, and the process returns to the previous step S105.

FIG. 9 is a flowchart showing an operation of the help mode, etc. to be executed when a touch input to the touch panel 22 is detected by execution of the touch detecting program 503 (FIG. 4). The touch detecting program is repeatedly executed for each predetermined time as described above, and determines whether or not there is a touch input on the touch panel 22 and detects touched coordinates indicating a touched position in a case that there is a touch input.

When a touch input is detected, the CPU 50 determines whether or not the help mode has already been turned on, that is, whether or not the help mode has been established at that time in a first step S1 in FIG. 9. Whether the help mode or not can be determined by checking the help mode flag (not illustrated) set to the temporary memory area 523 (FIG. 4). That is, when a transition to the help mode has already been made, the help mode flag is set to “1”, but if not, that is, in a case of a normal game mode, “0” is written to the help mode flag.

Since a transition to the help mode has not already been made at first, “NO” is determined in the step S1. Therefore, the CPU 50 determines whether or not the touched position detected in a touch detecting routine for executing the touch detecting program is at the position of the help mode key 104 shown in FIG. 5 in a next step S3. In the touch detecting routine, the touched coordinates indicating the touched position are detected, and the touched coordinates are temporarily stored in the temporary memory area 523 (FIG. 4). On the other hand, the help mode key 104 is displayed on the second LCD 18 according to the layout data as described above, and the layout data includes the image data of the help mode key 104 and data of its arrangement position as described above. Accordingly, in the step S3, by comparing the touched coordinates and the display area (arrangement position) of the help mode key 104, it is possible to easily make the determination.

When “NO” is determined in the step S3, it is determined whether or not the touched position at that time designates another object in a step S5. In the step S5 as well, the CPU 50 performs a determination operation on the basis of the data of the arrangement position included in the layout data and the touched coordinates. When “NO” is determined in the step S5, this is not relation to the game processing, and thus, the processing is returned.

When “YES” is determined in the step S5, the CPU 50 determines whether or not the touched position designates the return button 100 (FIG. 5) in a step S7. When “YES” is determined in the step S7, the process is returned as it is. Here, when “YES” is determined in the step S7, processing of being out of the scene that is currently being displayed is performed, and then, the processing may be returned.

That “NO” is determined in the step S7 means that the touched position at that time designates any one of the objects displayed on the second LCD 18, and therefore, in this case, in a step S9, appropriate processing is performed on the object. For example, in the normal game mode, processing of making the object jump and displaying the object in an enlarged/reduced manner is relevant.

When “YES” is determined in the preceding step S3, that is, when it is determined that the touched coordinates at that time designate the help mode key 104, the CPU 50 turns the help mode flag (not illustrated) on (writes “1”) in a succeeding step S11.

When a transition to the help mode is made, the CPU 50 executes processing according to the help mode program of the relevant scene number “i” thereafter.

Successively, the CPU 50 subsequently executes steps S13 to S19, but the order of the steps S13, S15, S17 and S19 may be changed. That is, the steps S13, S15, S17 and S19 can be executed according to an arbitrary order, but an explanation below is according to the order shown in FIG. 9.

In the step S13, the display manner of the help mode key 104 is changed. In the display example in FIG. 6, the “color” being one example of the display manner is changed from blue to yellow. However, the shape and the dimension (size) of the help mode key 104 may be changed separately from the color or together with the color. The reason why the display manner of the help mode key 104 is thus changed in the step S13 is because of clearly informing the user or the player of a transition to the help mode.

In the step S15, the layout data, that is, the image data and the arranging position information of the “?” cursor 108 corresponding to each of the target objects (objects that are displayed on the second LCD 18, and for each of which description message is prepared) are read. Then, in the step S17, according to the layout data read in the step S15, the “?” cursor 108 is displayed at a position near the target object displayed on the second LCD 18 as shown in FIG. 6, and the screen of the second LCD 18 is entirely grayed out. Thus, the “?” cursor 108 is displayed with respect to only the object (target object) for which the detailed explanation is prepared and stored in advance so as to be brought into association with each other, and therefore, the user or the player can immediately determine about which object the description message is prepared, that is, about which object the detailed explanation of the object and/or the function can be acquired with a look of the display screen in FIG. 6, for example. Accordingly, like those described in the related art, without actually clicking each object, by a mere transition to the help mode, the user or the player can be informed.

Thereafter, in the step S19, the display screen 106 including a description message (also including the images) that a transition to the help mode is made is displayed on the screen of the first LCD 16 as shown in FIG. 6. The description message is for informing the user or the player of a transition to the help mode and a using method of the help mode. After the step S19, the process is returned.

When a transition to the help mode has already been established at a time of detection of a touched position, that is, when it is determined that the help mode flag is turned on in the step S1 (“YES” in the step S1), the CPU 50 determines whether or not the touched position at that time is on any one of the “?” cursors 108 in a next step S21. The determination in the step S21 can also be executed by a comparison between the touched coordinates and the positional data of the layout data. The determination in the step S21 is for eventually determining whether or not the object itself about which a detailed explanation is desired is selected or designated through the selection of the “?” cursor 108. That is, the step S21 constructs of a first determiner.

When “YES” is determined in the step 521, the CPU 50 highlights the touched “?” cursor 108 and the target object (object 492 in the display example in FIG. 6) corresponding thereto according to the layout data in a succeeding step S23.

Then, the CPU 50 reads the description message data corresponding to the touched “?” cursor 108 (that is, the target object) that is stored in advance for the scene number “i” from the message data area 522 (FIG. 4) of the data memory area 52 in a step S25, and displays the description message 110 on the first LCD 16 as shown in. FIG. 7 according to the read description message in a succeeding step S27. After the step S27, the process is returned.

Here, if “NO” is determined in the step S21, in a next step S29, the CPU 50 determines whether or not the predetermined key or button, for example, the close key 102 (FIG. 5) in this embodiment is touched on the basis of the touched coordinates and the layout data. If “NO”, the process is returned as it is.

If “YES”, the help mode flag set to the temporary memory area 523 (FIG. 4) is turned off (“0” is written) in a step S31. In accordance therewith, in a step S33, the description message 110 and the “?” cursor 108 are totally erased, and the screen returns to the display state of the normal game screen shown in FIG. 5. The close key 102 can be touched on the screen in FIG. 6 (help mode before the description message has not already been displayed) and on the screen in FIG. 7 (help mode that the description message is being displayed), and therefore, the screen may return from FIG. 6 to FIG. 5, and may directly return to FIG. 5 from FIG. 7. Thus, when the close key 102 is touched, the marks like the “?” cursor 108 and the description messages 110 are totally erased in the step S33. Accordingly, the step S33 functions as an erasing means. After the step S33, the process returns.

Additionally, in the above-described embodiment, the “?” cursor 108 is displayed near the target object, but this may be displayed so as to be overlaid on the target object.

In addition, in this embodiment, the object (target object) about which the description message is set can be easily grasped by the user by displaying the “?” cursor 108 in association therewith. However, without using a special object such as the “?” cursor, but with merely using a highlight display, for example, the target object may be indicated. In this case, if the objects that are not the target object is grayed out, the highlight display is more outstanding, and this allows the user to easily find the target object. In this case, the presence or absence of the highlight display is a presence/absence indication, and the highlight display is a “presence indication”. Accordingly, in the modified example, in the step S21, it is determined whether or not the target object is touched (first determiner). Furthermore, making the display manner different between the target object and the other objects constructs of a different manner displaying means. In addition, in a case that the display manner is made different between the target object and the other objects by the different manner displaying means, when the close key 102 is operated, such a highlight display is canceled in the step S33 to make the display manner equal between the target object and the other objects.

According to the concept, by using the gray panel from which the part of the target object, the part except for the target object is grayed out, and the part of the target object is displayed so as not be gray, to thereby get the user notice that the object is the target object. In this case, whether to be grayed out or not is a presence/absence indication, and that the object is not grayed out is the “presence indication”. Accordingly, in the modified example as well, in the step S21, it is determined whether or not the target object is touched (first determiner). Making the display manner different between the target object and the other objects constructs of a different manner displaying means. In addition, in a case that the display manner is made different between the target object and the other objects by the different manner displaying means, when the close key 102 is operated, such a gray out display is canceled in the step S33 to make the display manner equal between the target object and the other objects.

In addition, in the above-described embodiment, the close key 102 is displayed on the second LCD 18 under the touch panel 22, and when the close key 102 is touched, the screen is returned from the help mode to the normal game screen. However, there is no need of especially providing the close key 102. In the help mode, the help mode key 104 that is displayed in the display manner different from the normal mode in the help mode may be utilized as a close key. In this case, in the step S29 in FIG. 9, it is determined whether or not the help mode key 104 is touched.

In addition, in the above-described embodiment, when the object is touched in the normal game mode, processing in association with the object is executed, and when the object (or “?” cursor) is touched in the help mode, the description message of the object is displayed. However, when the “?” cursor is touched in the help mode, the description message of the object is displayed, and when the object itself is touched, the processing in association with the object may be executed. Directly after the description message of the content of the object and the function is viewed, the object is touched to execute the processing, capable of improving operability.

In addition, in the above-described embodiment, a game apparatus is shown as one example of an information processing apparatus, and the detailed example of the information processing is described as the game processing. However, the invention is not restricted to the game apparatus and the game processing, and can be applied to an arbitrary information processing apparatus and information processing utilizing it. For example, the term of “game” used in the aforementioned description may be read as the term of “information processing”.

Furthermore, in the above-described embodiment, as an inputter for designating a position on the screen, a touch panel is used, but this may be changed to other pointing devices, such as a mouse, a track ball, etc.

Moreover, in the above-described embodiment, as an example of an object that requires the detailed explanation, the explanation is made on a game image (game object), but as such objects, button images, icons, etc. that executes a predetermined function and application in response to a user's designation are also conceivable.

In addition, in the above-described embodiment, the explanation is made that a computer of a single game apparatus executes all the steps (processing) in FIG. 8 and FIG. 9, for example. However, each processing may be performed to be shared with a plurality of apparatuses connected by a network, etc. For example, in a case that the game apparatus is connected to and communicated with other apparatuses (a server and other game apparatuses, for example), a part of the steps in FIG. 8 and FIG. 9 may be executed by the other apparatuses.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A storage medium storing an information processing program to be executed by a processor of an information processing apparatus that displays a plurality of objects on a screen of a monitor and has a storage storing a description message of at least one object, said information processing program causes said processor to function as:
a first displayer which displays a presence/absence indication for indicating whether or not there is a description message for each object on said screen when a predetermined input is accepted from an inputter;
a first determiner which determines whether or not the input accepted from said inputter designates a target object in association with any one of the presence indications; and
a second displayer which reads a relevant description message from said storage and displays the same on said screen when said first determiner determines that the target object in association with any one of the presence indications is designated.

2. A storage medium according to claim 1, wherein
said first displayer includes a differently displayer which displays a target object about which the description message is stored in said storage in a manner different from the other objects, and
said first determiner determines whether or not said input designates said target object.

3. A storage medium according to claim 1, wherein
said first displayer includes a mark displayer which displays a mark with respect to the target object about which the description message is stored, and
said first determiner determines whether or not said input designates said mark.

4. A storage medium according to claim 3, wherein
said mark displayer displays the mark near the corresponding target object.

5. A storage medium according to claim 3, wherein
said information processing program causes said processor to further function as:
a third determiner which determines whether or not the input accepted from said inputter designates any one of the objects, and
an executor which executes, when said third determiner determines that any one of the objects is designated, processing on the object.

6. A storage medium according to claim 1, wherein
said information processing program causes said processor to further function as a display manner changer which changes a display manner of at least the target object when said first determiner determines that the input accepted from said inputter designates the target object in association with any one of the presence indications.

7. A storage medium according to claim 1, wherein
said information processing program causes said processor to further function as
a second determiner which determines whether or not there is a predetermined input from said inputter in a state that said presence/absence indication is displayed by said first displayer, and
a presence/absence indication eraser which erases said presence/absence indication when said second determiner determines that there is a predetermined input.

8. A storage medium according to claim 1, wherein
said first displayer displays said presence indication as to each of all the objects about which a description message is prepared.

9. A storage medium according to claim 1, wherein
said information processing apparatus has a first display portion and a second display portion,
said target object is displayed on said first display portion,
said first displayer displays said presence/absence indication on said first display portion, and
said second displayer displays said description message on said second display portion.

10. A storage medium according to claim 1, wherein
said information processing apparatus has a touch panel, and
said inputter includes a touch detector which detects touch coordinates detected by a touch of said touch panel.

11. An information processing apparatus displaying a plurality of objects on a screen of a monitor, comprising:
a storage which stores a description message of at least one object;
a first displayer which displays a presence/absence indication for indicating whether or not there is a description message for each object when a predetermined input is accepted from an inputter;
a determiner which determines whether or not the input accepted from said inputter designates a target object in association with any one of the presence indications; and
a second displayer which reads a relevant description message from said storage and displays the same on said screen when said determiner determines that the target object in association with any one of the presence indications is designated.

12. An information processing method of an information processing apparatus that displays a plurality of objects on a screen of a monitor and has a storage storing a description message of at least one object, including following steps of:
a first displaying step for displaying a presence/absence indication for indicating whether or not there is a description message for each object when a predetermined input is accepted from an inputter;
a determining step for determining whether or not the input accepted from said inputter designates a target object in association with any one of the presence indications; and
a second displaying step for reading a relevant description message from said storage and displaying the same on said screen when said determiner determines that the target object in association with any one of the presence indications is designated.

13. An information processing system displaying a plurality of objects on a screen of a monitor, comprising:
a storage which stores a description message of at least one object;
a first displayer which displays a presence/absence indication for indicating whether or not there is a description message for each object when a predetermined input is accepted from an inputter;
a determiner which determines whether or not the input accepted from said inputter designates a target object in association with any one of the presence indications; and
a second displayer which reads a relevant description message from said storage and displays the same on said screen when said determiner determines that the target object in association with any one of the presence indications is designated.
